(19) United States
(12) Patent Application Publication
(10) Pub. No.: US 2017/0137609 A1
(43) Pub. Date: May 18, 2017

(54) POLYKETONE MOULDING COMPOUNDS WITH IMPROVED PROPERTIES, MOULDED ARTICLES PRODUCED THEREFROM AND ALSO METHOD FOR THE PRODUCTION THEREOF

(71) Applicant: EMS-PATENT AG, Domat/Ems (CH)

(72) Inventor: Georg STÖPPELMANN, Bonaduz (CH)

(73) Assignee: EMS-PATENT AG, Domat/Ems (CH)

(21) Appl. No.: 15/349,729

(22) Filed: Nov. 11, 2016

(30) Foreign Application Priority Data
Nov. 13, 2015 (EP) 15 194 563.1

(51) Int. Cl. C08K 7/14; C08K 5/5313; C08K 5/5393

(52) U.S. Cl. CPC C08K 7/14; C08K 5/5393; C08K 5/5313

(57) ABSTRACT

The present invention relates to polyketone moulding compounds based on partially crystalline, aliphatic polyketones. In particular, it relates to fibre-reinforced moulding compounds based on aliphatic polyketones which preferably comprise small quantities of phosphinic acid or the salts thereof. The moulding compounds are distinguished by improved mechanical properties and good processability in injection moulding. These moulding compounds are suitable for the production of in particular thin-walled moulded articles for the electrical and electronics industry, such as for example housings, housing components or connectors.

The present invention relates to polyketone moulding compounds based on partially crystalline, aliphatic polyketones. In particular, it relates to fibre-reinforced moulding compounds based on aliphatic polyketones which preferably comprise small quantities of phosphinic acid or the salts thereof. The moulding compounds are distinguished by improved mechanical properties and good processability in injection moulding. These moulding compounds are suitable for the production of in particular thin-walled moulded articles for the electrical and electronics industry, such as for example housings, housing components or connectors.

### STATE OF THE ART

Aliphatic polyketones have been known for many years and are distinguished by virtually constant mechanical properties between 10 and 100° C., very good hydrolysis resistance, high thermal dimensional stability, good resistance to wear and tear and a good barrier against fuels.

On the other hand, aliphatic polyketones, although they represent thermoplastic plastic materials with thoroughly good properties, have the disadvantage that they have relatively high melting points which are close to temperatures at which they are subject to chemical decomposition, in particular inter- and intramolecular aldol condensation reactions. This is problematic since the polyketone moulding compounds are, on the one hand, difficult to process in the melt when using normal processing technologies and, on the other hand, the properties of such moulding compounds can be affected detrimentally by the decomposition- and crosslinking reactions induced during processing.

In order to overcome these problems, various possible solutions are proposed in the literature. For example EP213671 and EP257663 describe aliphatic polyketones based on carbon monoxide, ethene and at least one further olefinically unsaturated monomer which have lower melting points than corresponding polyketone copolymers formed exclusively from carbon monoxide and ethene. The terpolymers shown by way of example can be processed at 20-30° C. lower temperatures at which the thermal decomposition and the crosslinking proceeds more slowly. Hence, these terpolymers have a larger processing window. DE2626272 pursues the same aim with a polymer-analogous conversion of the polyketones with primary monoamines, mono- or dithiols, the melting point of the original polyketone being able to be decreased by up to 80° C.

This solution approach mitigates the problem to a certain degree but does not resolve all of the problems during processing of polyketones in the melt. Thus, for further improvement in the polyketone moulding compounds, compositions are described which are based on the addition of other polymers, such as e.g. polyamide or polyolefin, the addition of plasticisers or the use of special additives. The use of further polymers has the disadvantage however that relatively large quantities thereof are required and hence in particular the thermal and mechanical properties are overall impaired. As a function of the added polymer, in addition undesired reactions with the polyketone can take place, as a result of which the properties of the formed moulding compounds are at a low level. On the other hand, plasticisers only represent a practicable solution approach if flexible moulding compounds are required.

The addition of aluminium-oxygen compounds is described in EP310166 and EP326224. For example, aluminium hydroxide is intended thus to ensure an improvement in the flow behaviour of polyketones because crosslinking at the processing temperature takes place delayed by the additive and proceeds also more slowly over the processing duration.

According to EP629663 or EP896021, the melt processing of polyketones can be further improved by the addition of 0.01 to 10% of pseudoboehmite. Pseudoboehmite thereby prevents the all too rapid increase in melt viscosity at processing temperatures of 20 K above the melting temperature of the polyketones.

According to JP11-181080, additives, such as aluminium- or magnesium oxide, can indeed improve the flow behaviour during the processing but do not prevent generation of volatile compounds due to decomposition of the polyketones. In order to reduce or prevent degassing, the treatment of the polyketones with ammonia or primary amines is proposed.

DE19808938 relates inter alia to the stabilisation of polycarbonate, polyester and polyketone against oxidative, thermal and light-induced decomposition, additional stabilisers being able to be added to the polymer, in addition to a benzofuran-2-one compound, inter alia phosphites and phosphinates.

If it is intended that the colour and the crystallinity of the polyketone moulding compounds are still preserved beyond the processing, in addition to the flowability, EP896021 recommends the addition of a combination of aluminium hydroxide and polyol.

EP322959 describes fibre-reinforced polyketone moulding compounds, in particular moulding compounds reinforced with glass fibres, and also a method for producing this moulding compound from a polyketone solution. The aim is to increase the strength and the modulus of the moulding compounds.

### PRESENTATION OF THE INVENTION

Accordingly, the object underlying the invention, inter alia, is to provide moulding compounds based on partially crystalline, aliphatic poylketones which are equipped with reinforcing fibres and also phosphinic acids or the salts thereof and are distinguished by improved mechanical properties and also good processability in the injection moulding process. In particular, the breaking strength, the breaking elongation and the impact strength are intended to be improved relative to the state of the art. Furthermore, it is required that the moulding compounds should have sufficiently high flowability in order to be able produce even thin-walled moulded parts with good quality.

This object is achieved according to the invention by the polyketone moulding compounds according to claim 1. With patent claim 13, moulded articles with are obtainable from the polyketone moulding compounds according to the invention are provided. Patent claim 14 relates to a method for the production of a moulded article according to the invention. The respective dependent patent claims thereby represent advantageous developments.

The present invention hence relates to a polyketone moulding compound comprising or consisting of
(A) 25-99.9% by weight of at least one aliphatic polyketone;
(B) 0-70% by weight of filling- or reinforcing materials;
(C) 0.1-6% by weight of at least one phosphorus-containing compound, selected from the group consisting of
   (C1) 0-6% by weight of at least one phosphinic acid or at least one diphosphinic acid, a metal salt and/or an organic derivative thereof;
   (C2) 0-2% by weight of at least one organic phosphite or phosphonite,
   at least one of the phosphorus-containing compounds (C1) and (C2) being present in the polyketone moulding compound, so that the sum of the phosphorus-containing compounds (C1) and (C2) is at least 0.1% by weight,
(D) 0-20% by weight of at least one additive,
   the sum of (A) to (D) producing 100% by weight, the content data for (A) to (D) including (C1) and (C2) respectively relating to the moulding compound or the sum of (A) to (D) and the moulding compound preferably consisting exclusively of components (A) to (D).

The percentages by weight of components A to D together thereby produce 100% and preferably finally form the total polyketone moulding compound.

The concentrations or concentration ranges, indicated here and subsequently, relate respectively either to the sum of components A to D in the case where the moulding compound is formulated open (“comprising”) or to the total moulding compound in the case where the moulding compound is formulated closed (“consisting of”). In the latter case, the moulding compound consists exclusively of components A to D.

A preferred embodiment provides that, in the case of the polyketone moulding compound according to the invention, respectively independently of each other or in combination with each other, the content
(A) of the at least one aliphatic polyketone is 32 to 89.7% by weight, preferably 41 to 84.5% by weight and very particularly preferably 44 to 79.5 or 49 to 69.5% by weight,
(B) of the filling- or reinforcing materials is 10 to 60% by weight, preferably between 15 to 55% by weight, further preferably 20 to 50% by weight and very particularly preferably 30 to 45% by weight,
(C) of the at least one phosphorus-containing compound is 0.2 to 4% by weight, preferably 0.3 to 3% by weight and very particularly preferably 0.8 to 3% by weight, and also
(D) of the at least one additive is 0.1 to 6% by weight, preferably 0.2 to 3% by weight.

### Component (A)—Aliphatic Polyketones

The aliphatic polyketones used according to the invention concern thermoplastic polymers with a linear alternating structure which essentially comprise one carbon monoxide molecule per molecule of an unsaturated hydrocarbon. Suitable unsaturated hydrocarbons are in particular olefins with up to 20 carbon atoms, preferably up to 10 carbon atoms, such as e.g. ethene and other α-olefins including propene, 1-butene, isobutene, 1-hexene, 1-octene and 1-dodecene. Furthermore, also olefinically unsaturated compounds with aryl substituents, such as e.g. styrene, p-methylstyrene, p-ethylstyrene and m-isopropylstyrene, are suitable as monomer.

Aliphatic polyketones which are preferred in the sense of the invention are alternating copolymers made of carbon monoxide and ethene or terpolymers made of carbon monoxide, ethene and a second ethylenically unsaturated hydrocarbon with at least 3 carbon atoms, in particular with an α-olefin such as propene or 1-butene.

In particular, the polyketone used according to the invention concerns a terpolymer of the subsequent general formula

*CH₂—CH₂—COₓ(Q-CO_{y}*

wherein Q is a divalent group, derived from olefinically unsaturated compounds with at least 3 carbon atoms, and the molar ratio y:x is less than or equal to 0.5, preferably less than 0.2, in particular less than or equal to 0.1, in particular is of 0.01 to 0.1. Q is in particular the divalent unit —CH₂—CH(CH₃)—, which is derived from propene.

According to a preferred embodiment, the at least one aliphatic polyketone is a partially crystalline polyketone, preferably with a melting temperature, measured by means of DSC according to ISO 11357-3 at a heating rate of 20 K/min, in the range of 180° C. to 280° C., in particular of 200 to 240° C.

Further advantageously, the aliphatic polyketone has a melt viscosity (MVR, melt volume-flow rate), determined according to ISO 1133 at 240° C. and with an overlay of 2.16 kg, in the range of 5-200 cm³/10 min, in particular in the range of 10-100 cm³/10 min, very particularly preferably in the range of 20-80 cm³/10 min.

Likewise, it is possible that the aliphatic polyketone has a relative viscosity, measured at a polymer concentration of 0.5 g polymer dissolved in 100 ml m-cresol at 20° C. with a capillary viscometer, of 1.5 to 2.5, preferably of 1.6 to 2.2.

The previously mentioned properties of the aliphatic polyketones can occur alternatively or cumulatively.

The aliphatic polyketone is distinguished furthermore by a preferred number-average molar mass, determined by means of GPC in hexafluoroisopropanol relative to PMMA standards, in the range of 20,000 to 100,000 g/mol, in particular of 30,000 to 60,000 g/mol.

Preferably useable aliphatic polyketone polymers are known per se. For example, U.S. Pat. No. 4,880,903 describes a linear alternating polyketone-terpolymer made of carbon monoxide, ethene and other olefinically unsaturated hydrocarbons, in particular propene. In the methods for the production of aliphatic polyketones, generally the use of a catalyst composition made of a compound of a metal of group VIII is provided, selected from palladium, cobalt or nickel, the anion of a strong acid, not belonging to the halogen acids and a bidentate phosphorus-, arsenic- or antimony ligand. In U.S. Pat. No. 4,843,144, a method for the production of linear alternating polyketone polymers made of carbon monoxide and at least one olefinically unsaturated hydrocarbon is described, in which a catalyst is used which comprises a palladium compound, the anion of an acid not belonging to the halogen acids with a pKa value below 6 and a bidentate phosphorus ligand. The polymerisation is implemented for example in methanol which assumes, at the same time, an initiator- and a chain transfer function so that polyketones produced in this way have a typical end group pattern of keto- and ester groups. All of the polyketones disclosed in these patent specifications are suitable preferably also for the purposes of the present invention. The disclosure content in this respect of the previously mentioned US patents is consequently also included jointly in the present application.

### Component (B)—Filling- and Reinforcing Materials

Preferred filling- or reinforcing materials which are suitable for the purposes of the present invention are thereby selected from the group consisting of fibrous or particulate filling materials or the mixtures thereof, which are equipped preferably with a size and/or an adhesive.

In a preferred embodiment, the polyketone moulding compounds according to the invention comprise in addition filling- and reinforcing materials (component B), in particular exclusively reinforcing materials.

As component (B), the moulding compounds according to the invention can comprise 10-60% by weight, preferably between 15-55% by weight, further preferably 20-50% by weight and very particularly preferably between 30 and 45% by weight, of filling- or reinforcing materials or mixtures thereof.

Reinforcing materials, also termed reinforcing fibres, are generally selected preferably from the group of glass fibres, carbon fibres (carbon fibres, graphite fibres), metal fibres, aramide fibres (p- or m-aramide fibres (e.g. Kevlar® or Nomex®, DuPont)), basalt fibres and whiskers, such as e.g. potassium titanate whiskers and also mixtures or combinations thereof.

The glass fibres used as reinforcing materials are present preferably in the form of endless strands (rovings) or in cut form, in particular in the form of short glass fibres (cut glass).

For improving the compatibility with the polyketones, the filling materials, in particular fibres such as e.g. glass fibres, are preferably equipped with a size and/or an adhesive.

Preferably glass fibres made of E-glass are used as filling materials of component (B).

In general, fibres of component (B) can have a circular cross-section or a non-circular cross-section, also mixtures of such systems being able to be used.

Preferably, in the case of round fibres, those with a diameter of 5 to 20 μm, preferably of 6 to 15 μm and particularly preferably of 7 to 12 μm are used.

In the case of flat fibres, those which have a ratio of cross-sectional axes, which are perpendicular to each other, greater than or equal to 2, in particular in the range of 2.8-4.5, are preferred and the smaller cross-sectional axis thereof has a length of ≧4 μm.

The glass fibres thereby consist preferably of E-glass. However, also all other sorts of glass fibre, such as e.g. A-, C-, D-, M-, S-, R-glass fibres or any mixtures thereof or mixtures with E-glass fibres, can be used. The glass fibres can thereby be added as endless fibres or as cut glass fibres, the fibres being able to be equipped with a suitable sizing system and an adhesive or adhesive system, e.g. based on silane, aminosilane or epoxysilane. Preferably, cut glass, so-called short glass fibres made of E- or S-glass, are used. Polar sizes are preferred as are also used for polyesters or polyamides.

Preferably, the glass fibres (B) are selected from the group consisting of:
E-glass fibres (these consist, according to ASTM D578-00, of 52-62% silicon dioxide, 12-16% aluminium oxide, 16-25% calcium oxide, 0-10% borax, 0-5% magnesium oxide, 0-2% alkali oxides, 0-1.5% titanium dioxide and 0-0.3% iron oxide; preferably, they have a density of 2.58±0.04 g/cm³, a modulus of elasticity in tension of 70-75 GPa, a tensile strength of 3,000-3,500 MPa and a tearing elongation of 4.5-4.8%),
A-glass fibres (63-72% silicon dioxide, 6-10% calcium oxide, 14-16% sodium- and potassium oxide, 0-6% aluminium oxide, 0-6% boron oxide, 0-4% magnesium oxide),
C-glass fibres (64-68% silicon dioxide, 11-15% calcium oxide, 7-10% sodium- and potassium oxide, 3-5% aluminium oxide, 4-6% boron oxide, 2-4% magnesium oxide),
D-glass fibres (72-75% silicon dioxide, 0-1% calcium oxide, 0-4% sodium- and potassium oxide, 0-1% aluminium oxide, 21-24% boron oxide), basalt fibres (mineral fibre with the approximate composition: 52% SiO₂, 17% Al₂O₃, 9% CaO, 5% MgO, 5% Na₂O, 5% iron oxide and also further metal oxides),
AR-glass fibres (55-75% silicon dioxide, 1-10% calcium oxide, 11-21% sodium- and potassium oxide, 0-5% aluminium oxide, 0-8% boron oxide, 0-12% titanium dioxide, 1-18% zirconium oxide, 0-50% iron oxide),
S-, HS- or T-glass fibres (58-70% by weight of silicon dioxide (SiO2), 15-30% by weight of aluminium oxide (Al₂O₃), 5-15% by weight of magnesium oxide (MgO), 0-10% by weight of calcium oxide (CaO) and 0-2% by weight of further oxides, such as e.g. zirconium dioxide (ZrO₂), boron oxide (B₂O₃), titanium dioxide (TiO₂) or lithium oxide (Li₂O)) and also mixtures thereof.

Alternatively and likewise preferably, the glass fibres can also be present as endless fibres, such endless fibres are also technically termed rovings. Preferably, the endless fibres have a round cross-section and a diameter in the range of 10 to 20 in particular 12-17 μm. Likewise, embodiments in which both endless fibres and short fibres are contained are conceivable.

Preferably, also fibres, preferably glass fibres, with a non-circular cross-section (flat glass fibres), in particular oval, elliptical, cocoon-like (two or more round glass fibres are joined together longitudinally) or rectangular or almost rectangular glass fibres, can also be used in the moulding compounds according to the invention.

Glass fibres with a non-circular cross-section (flat glass fibres), preferably have a dimensioning of the main cross-sectional axis in the range of 10 to 35 μm, in particular in the range 18 to 32 μm and a length of the subsidiary cross-sectional axis in the range of 3 to 15 μm, in particular in the range of 4 to 10 μm.

These moulding compounds then display advantages with respect to rigidity and strength, in particular in the transverse direction, in the case of the moulded parts produced from the moulding compounds. The preferably used flat glass fibres (component (B)) are short glass fibres (cut glass) with a flat shape and a non-circular cross-sectional area, the ratio of the cross-sectional axes, which are perpendicular to each other, being greater than or equal to 2, and the smaller cross-sectional axis having a length of ≧4 In particular, a glass fibre which is as rectangular as possible in cross-section is preferred. The glass fibres are present in the form of cut glass with a length of 2 to 50 mm. These glass fibres have preferred diameters of the small cross-sectional axis of 4 to 10 μm and a diameter of the large cross-sectional axis of 8 to 30 μm, the ratio of cross-sectional axes, which are perpendicular to each other (ratio of main to subsidiary cross-sectional axis), being between 2 and 6, preferably between 2.5 and 5 and very particularly preferably at 2.8 to 4.5.

The glass fibres can be replaced partially or entirely by whiskers. There should be understood by whiskers, needle-shaped crystals, in particular monocrystals made of metals, oxides, borides, carbides, nitrides, polytitanate, carbon etc. with usually a polygonal cross-section, e.g. potassium titanate-, aluminium oxide-, silicon carbide whiskers. In general whiskers have a diameter of 0.1 to 10 μm and a length in the mm- to cm range. At the same time, they have a high tensile strength. Whiskers can be produced by deposition from the vapour phase on the solid body (VS mechanism) or from a three-phase system (VLS mechanism).

The moulding compounds according to the invention can also comprise carbon fibres, alone or together with other reinforcing fibres. Carbon fibres are industrially produced reinforcing fibres made of carbon-containing starting materials which are converted by pyrolysis (oxidation and carbonisation) into graphite-like-arranged carbon. Anisotropic carbon fibres display high strengths and rigidities with simultaneously low breaking elongation in the axial direction.

Normally, carbon fibres are produced by a suitable polymer fibre made of polyacrylonitrile, pitch or rayon being subjected to alternating controlled conditions of temperature and atmosphere. For example, carbon fibres can be produced by stabilisation of PAN threads or -woven fabrics in an oxidative atmosphere at 200 to 300° C. and subsequent carbonisation in an inert atmosphere above 600° C. Such methods are state of the art and described for example in H. Heiβler, “Verstärkte Kunststoffe in der Luft- and Raumfahrt” (“Reinforced Plastic Materials in Aviation and Space Travel”), W. Kohlhammer Press, Stuttgart. 1986.

Carbon fibre bundles consist of several hundred to a hundred thousand carbon fibres, so-called individual filaments, which have a diameter of 5 to 9 μm, a tensile strength of 1,000 to 7,000 MPa and a modulus of elasticity of 200 to 700 GPa. Normally, 1,000 to 24,000 individual filaments are combined to form a multifilament yarn (endless carbon fibre bundle, roving) which is wound up. Further processing to form textile semi-finished products, such as e.g. woven fabrics, plaited fabrics or multiaxial flat fabrics is effected on weaving machines, plaiting machines or multiaxial knitting machines or, in the field of production of fibre-reinforced plastic materials, directly on prepreg units, strand-drawing units (pultrusion units) or winding machines. As short cut fibres, polyketones can be mixed therein and processed via extruder- and injection moulding units to form plastic material components.

Particulate filling materials of component (B) are preferably on a mineral basis, particularly preferably are selected based on talc, mica, silicate, quartz, titanium dioxide, wollastonite, kaolin, amorphous silicic acids, magnesium carbonate, magnesium hydroxide, chalk, lime, feldspar, solid or hollow glass balls or ground glass, glass flakes, permanently magnetic or magnetisable metal compounds and/or alloys, pigments, in particular barium sulphate, titanium dioxide, zinc oxide, zinc sulphide, iron oxide, copper chromite, or mixtures thereof. The filling materials can also be surface-treated.

### Component (C):

Furthermore, the moulding compound according to the invention comprises 0.1-6% by weight, preferably 0.2-4% by weight, further preferably 0.3-3% by weight and in particular 0.8-3% by weight, of a phosphorus-containing compound as component (C).

Component (C) is preferably contained in the moulding compound up to 0.10 to 6.00% by weight and preferably consists either of

0.10-6.00% by weight of phosphinic acid or diphosphinic acid or a metal salt of these phosphinic acids (component C1), or
0.10-2.00% by weight of an organic phosphite or phosphonite (component C2), or
0.10-6.00% by weight of a mixture of a phosphinic acid or diphosphinic acid or a metal salt of these phosphinic acids (component C1) and of an organic phosphite or phosphonite (component C2),
the mixture consisting up to 0.05-2.00% by weight of component C2 and up to 0.05-5.95% by weight of component C1.

In the case where component (C) consists exclusively of organic phosphites or phosphonites (component (C2)), the upper limit of the total content of component (C) in total is limited hence to 2% by weight.

In a preferred embodiment, component (C) is contained in the moulding compound up to 0.20 to 4.00% by weight and preferably consists either of

0.20-4.00% by weight of phosphinic acid or diphosphinic acid or a metal salt of these phosphinic acids (component C1), or
0.20-2.00% by weight of an organic phosphite or phosphonite (component C2), or
0.20-4.00% by weight of a mixture of a phosphinic acid or diphosphinic acid or a metal salt of these phosphinic acids (component C1) and of an organic phosphite or phosphonite (component C2),
the mixture consisting up to 0.10-2.00% by weight of component C2 and up to 0.10-5.90% by weight of component C1.

In a further preferred embodiment, component (C) is contained in the moulding compound up to 0.30 to 3.00% by weight and preferably consists either of

0.30-3.00% by weight of phosphinic acid or diphosphinic acid or a metal salt of these phosphinic acids (component C1), or
0.30-1.00% by weight of an organic phosphite or phosphonite (component C2), or
0.30-3.00% by weight of a mixture of a phosphinic acid or diphosphinic acid or a metal salt of these phosphinic acids (component C1) and of an organic phosphite or phosphonite (component C2),
the mixture consisting up to 0.10-1.00% by weight of component C2 and up to 0.20-2.90% by weight of component C1.

It is particularly preferred if component (C) is contained in the moulding compound up to 0.80 to 3.00% by weight and preferably either consists of

0.80-3.00% by weight of phosphinic acid or diphosphinic acid or a metal salt of these phosphinic acids (component C1), or
0.80-3.00% by weight of a mixture of a phosphinic acid or diphosphinic acid or a metal salt of these phosphinic acids (component C1) and an organic phosphate or phosphonite (component C2),
the mixture consisting up to 0.10-1.00% by weight of component C2 and up to 0.70-2.90% by weight of component C1.

All concentration data mentioned for C, C1 and C2 respectively relate to the polyketone moulding compound or the sum of A to D.

According to a preferred embodiment, component (C1) is a phosphinic acid (M=H⁺) or a phosphinic acid salt (M=metal cation) of the general formula (I) and/or formula (II) and/or the polymers thereof:

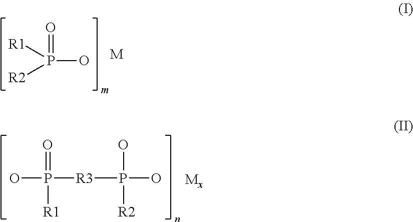

wherein
R1, R2 are the same or different and preferably are C1-C8 alkyl, linear or branched, saturated, unsaturated or partially unsaturated and/or aryl;

R3 is C1-C10 alkylene, linear or branched, saturated, unsaturated or partially unsaturated, C6-C10 arylene, alkylarylene or arylalkylene;

M is a hydrogen ion (proton) or a metal ion from the 2^{nd} or 3^{rd} main or subsidiary group of the periodic table, preferably aluminium, barium, calcium and/or zinc; and m=2 or 3; n=1 or 3; x=1 or 2.

Preferably, aluminium, barium, calcium, magnesium and zinc are used as metal ion M.

Suitable phosphinic acids as component (C1) and also for the production of the phosphinic acid salts (component C1) according to the invention are for example dimethylphosphinic acid, ethylmethylphosphinic acid, diethylphosphinic acid, methyl-n-propylphosphinic acid, methanedi(methylphosphinic acid), ethane-1,2-di(methylphosphinic acid), hexane-1,6-di(methylphosphinic acid), benzene-1,4-di(methylphosphinic acid), methylphenylphosphinic acid, diphenylphosphinic acid. The phosphinic acid salts can be produced for example by converting the phosphinic acids in aqueous solution with metal carbonates, metal hydroxides or metal oxides, essentially monomeric, according to the reaction conditions, possibly also polymeric phosphinic acid salts being produced.

Particularly preferred as component C1 are the aluminium-, calcium- and zinc salts of the above-indicated phosphinic acids. Aluminium-tris-diethylphosphinate is particularly preferred.

Preferred organic phosphites and phosphonites are triphenylphosphite, diphenylalkylphosphite, phenyldialkylphosphite, tris(nonylphenyl)phosphite, trilaurylphosphite, trioctadecylphosphite, di stearylpentaerythritol diphosphite, tris(2,4-di-tert-butylphenyl)phosphite, diisodecylpentaerythritol diphosphite, bis(2,4-di-tert-butylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris-(tert-butylphenyl))pentaerythritol diphosphite, tristearylsorbitol triphosphite, tetrakis(2,4-di-tert-butylphenyl)-4,4′-biphenylene diphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyldibenzo[d,g]-1,3,2-dioxaphosphocine, bis(2,4-di-tert-butyl-6-methylphenyl)methylphosphite and bis(2,4-di-tert-butyl-6-methylphenyl)ethylphosphite. In particular, tris[2-tert-butyl-4-thio(2′-methyl-4′-hydroxy-5′-tert-butyl)phenyl-5-methyl]phenylphosphite and tris(2,4-di-tert-butylphenyl)phosphite are preferred.

In particular, bis(2,6-di-t-butyl-4-methylphenyl)pentaerythritol diphosphite, tris[2-tert-butyl-4-thio(2′-methyl-4′-hydroxy-5′-tert-butyl)phenyl-5-methyl]phenylphosphite, tris(2,4-di-tert-butylphenyl)phosphite and tetrakis(2,4-di-t-butylphenyl)-4,4′-biphenylene diphosphonite (Sandostab P-EPQ″ produced by Clariant) are preferred.

### Component (D)

As component (D), the moulding compounds comprise 0-20% by weight, preferably 0-10% by weight, further preferably 0.1-6% by weight and particularly preferably 0.2 to 3% by weight, of at least one additive or processing aid.

It should hereby be emphasised that the additives of component (D) are different from the other components (A)-(C).

The moulding compounds can comprise stabilisers (heat- and light stabilisers, antioxidants), processing aids and further polymers, in particular polyolefins, acid- or anhydride-modified polyolefins, polyesters, polyamides, in particular aliphatic polyamides, impact modifiers and further additives.

Component (D) normally generally concerns additives and/or further polymers, for example selected from the following group: impact modifiers, adhesives, crystallisation accelerators or retarders, flow aids, lubricants, mould-release agents, plasticisers, stabilisers, in particular UV and heat-stabilisers, antioxidants, radical collectors, processing aids, antistatic agents, colouring- and marking substances, nanoparticles in lamellar form, layer silicates, conductivity additives, such as carbon black, graphite powder or carbon nanofibrils, residues from polymerisation processes, such as catalysts, salts and derivatives thereof, oxygen-, nitrogen- or sulphur-containing metal compounds and also regulators, such as e.g. monoacids or monoamines.

Preferred oxygen-, nitrogen- or sulphur-containing metal compounds within component (D) are based mainly on the metals aluminium, calcium, magnesium and zinc. Suitable compounds are selected from the group of oxides, hydroxides, carbonates, silicates, borates, phosphates, stannates and also combinations or mixtures of these compounds, such as e.g. oxide-hydroxides or oxide-hydroxide-carbonates. Examples are magnesium oxide, calcium oxide, aluminium oxide, zinc oxide, aluminium hydroxide, boehmite, pseudoboehmite, bayerite, dihydrotalcite, hydrocalumite, calcium hydroxide, calcium hydroxylapatite, tin oxide hydrate, zinc hydroxide, zinc borate, zinc sulphide, zinc phosphate, calcium carbonate, calcium phosphate, magnesium carbonate, basic zinc silicate, zinc stannate, barium stearate, calcium stearate, zinc stearate, magnesium stearate, potassium palmitate, magnesium behenate.

Preferably, the moulding compounds according to the invention are thereby free of maleic anhydride-grafted PE and/or PP adhesives.

There is preferred a polyketone moulding compound consisting of
(A) 38-89.2% by weight of at least one aliphatic polyketone;
(B) 10-60% by weight of glass fibres, carbon fibres or mixtures thereof;
(C) 0.8-6% by weight of at least one phosphorus-containing compound, selected from the group consisting of
   (C1) 0-6% by weight of at least one phosphinic acid or at least one diphosphinic acid, a metal salt and/or an organic derivative thereof;
   (C2) 0-2% by weight of at least one organic phosphite or phosphonite
   at least one of the phosphorus-containing compounds (C1) and (C2) being present in the polyketone moulding compound, so that the sum of the phosphorus-containing compounds (C1) and (C2) is at least 0.8% by weight,
(D) 0.1-6% by weight of at least one additive,
   the sum of (A) to (D) producing 100% by weight, the content data for (A) to (D) including (C1) and (C2) respectively relating to the moulding compound or the sum of (A) to (D).

It is thereby preferred in particular if component (C) consists either of 0.80-6.00% by weight of phosphinic acid or diphosphinic acid or a metal salt of these phosphinic acids (component C1), or

0.80-6.00% by weight of a mixture of a phosphinic acid or diphosphinic acid or a metal of these phosphinic acids (component C1) and of an organic phosphite or phosphonite (component C2), the mixture consisting up to 0.10-2.00% by weight, in particular up to 0.10-1.00% by weight, of component C2 and up to 0.70-5.90% by weight of component C1.

Furthermore, the invention also relates to moulded articles, to the use of the above-described moulding compounds for the production of thermoplastically processable moulded articles and also to moulded articles obtainable from the compositions according to the invention.

Examples of such moulded articles include: housings and functional parts for pumps, transmissions, valves and water meters, throttle valves, cylinders, pistons, headlight housings, reflectors, bend-light adjustment, toothed wheels, engine- and transmission bearings, plug-in connections, connectors, profiles, foils or layers of multilayer foils, fibres, electronic components, in particular components for portable electronic devices, housings for electronic components, connectors, mobile telephone housings, components for LED housings, housings or housing parts for personal computers, in particular notebook housings, tools, composite materials, fluid-conducting pipes and containers, in particular in the automobile sphere, smooth and corrugated mono- or multilayer pipes, pipe sections, connection pieces, fittings for connecting hoses, corrugated pipes and media-conducting pipes, components of multilayer pipes (inner-, outer- or intermediate layer), individual layers in multilayer containers, hydraulic pipes, brake pipes, clutch pipes, coolant pipes, brake fluid containers etc.

The moulded articles are producible by the methods of injection moulding, extrusion or blow-moulding.

### DESCRIPTION OF PREFERRED EMBODIMENTS

Preferred embodiments of the invention are described subsequently with reference to embodiments, given by way of example, which serve only for explanation and should not be interpreted as restrictive.

### Production of the Polyketone Moulding Compounds:

The raw materials of components (A), (C) and (D) are mixed in advance and metered gravimetrically into the feed of a twin-screw extruder of the type ZSK25 (Werner and Pfleiderer). Component (B) is metered into the melt via a sidefeeder 4 housing units in front of the discharge. The process takes place at cylinder temperatures of 200-270° C. at a screw speed of rotation of 200 rpm and a throughput of 10 kg/h. The compound is discharged via a nozzle and granulated after cooling the strand. Subsequently drying takes place at 100° C. for 24 h in a vacuum.

### Production of the Moulded Articles:

The production of the moulded articles is effected on an injection moulding machine, Arburg Allrounder 420C-1000-250, with a rising cylinder temperature profile in the range of 200-270° C. and injection pressures of 1,000-1,800 bar. The mould temperature is 80° C. The geometry of the moulded articles corresponds to the specifications of the corresponding testing standards.

The following materials were used:
PK-EP (LV): Low-viscous aliphatic polyketone made of carbon monoxide, ethylene and propylene with a melting point of 220° C., MFR (240° C., 2.16 kg) of
PK-EP (HV): Highly viscous aliphatic polyketone made of carbon monoxide, ethylene and propylene with a melting point of 220° C., MFR (240° C., 2.16 kg) of 6 g/10 min, Hyosung Co. Ltd.
PA12: Polyamide PA12, solution viscosity of ηrel=1.95 (0.5 g polymer dissolved in 100 ml m-cresol, 20° C.), melting point of 178° C., EMS-CHEMIE AG.
Polybond 3002: Maleic anhydride-modified polypropylene, BP Performance Polymers Inc
Exolit OP1230: Aluminium-tris-diethylphosphinate, Clariant, CH
Magnefin H10 IV: High-purity magnesium hydroxide, Albemarle
Glass fibre: Glass fibre with a round cross-section for polyamides, fibre length 4.5 mm, diameter 10 μm, Vetrotex
Sandostab P-EPQ: Tetrakis(2,4-di-t-butylphenyl)-4,4′-biphenylene diphosphonite (CAS: 38613-77-3), Clariant
Stabiliser: Irganox 1010, sterically hindered phenolic antioxidant (BASF SE)

The compositions of the moulding compounds and the properties of the moulded articles according to the invention produced therefrom are compiled in Table 1, comparative examples are indicated in Table 2.

TABLE 1
Examples E1-E6 according to the invention:

| | | E1 | E2 | E3 | E4 | E5 | E6 |
|---|---|---|---|---|---|---|---|
| PK-EP (LV) | % by weight | 69.3 | 68.3 | 48.45 | 38.45 | 64.3 | 67.3 |
| Glass fibres | % by weight | 30.0 | 30.0 | 50.0 | 60.0 | 30.0 | 30.0 |
| Sandostab P-EPQ | % by weight | 0.2 | 0.2 | 0.15 | 0.15 | 0.2 | 0.2 |
| Exolit OP1230 | % by weight | | 1.0 | 1.0 | 1.0 | 5.0 | 2.0 |
| Irganox 1010 | % by weight | 0.5 | 0.5 | 0.4 | 0.4 | 0.5 | 0.5 |

Properties

| | | | | | | | |
|---|---|---|---|---|---|---|---|
| Modulus of elasticity | MPa | 8,400 | 8,500 | 13,800 | 16,300 | 9,000 | 8,400 |
| Breaking strength | MPa | 135 | 136 | 175 | 173 | 137 | 139 |
| Breaking elongation | % | 3.5 | 5 | 3.2 | 3.1 | 5.2 | 5.3 |
| Impact 23° C. | kJ/m² | 72 | 93 | 77 | 65 | 85 | 95 |
| Impact −30° C. | kJ/m² | 66 | 87 | 64 | 64 | 84 | 85 |
| Notch impact 23° C. | kJ/m² | 16 | 14 | 18 | 17 | 14 | 17 |
| Notch impact −30° C. | kJ/m² | 11 | 11 | 14 | 12 | 10 | 12 |
| HDT A (1.80 MPa) | ° C. | 207 | 204 | 212 | 212 | 205 | 208 |
| HDT C (8.00 MPa) | ° C. | 158 | 143 | 185 | 183 | 155 | 164 |
| MVR (250° C./21.6 kg) | cm³/10 min | 152 | 126 | 78 | 5 | 86 | 115 |

% by weight = percent by weight

TABLE 2
comparative examples CE1-CE7

| | | CE1 | CE2 | CE3 | CE4 | CE5 | CE6 | CE7 |
|---|---|---|---|---|---|---|---|---|
| PK-EP (LV) | % by weight | 69.5 | 49.5 | 68.5 | 64.5 | 34.7 | 64.6 | 64.0 |
| PK-EP (HV) | % by weight | | | | | 34.8 | | |
| Polybond 3002 | % by weight | | | | | | 5.0 | |
| PA12 | % by weight | | | | | | | 5.0 |
| Glass fibres | % by weight | 30.0 | 50.0 | 30.0 | 30.0 | 30.0 | 30.0 | 30.0 |
| Exolit OP1230 | % by weight | | | | | | | |
| Magnifin H10 IV | % by weight | | | 1 | 5 | | | |
| Stabiliser | % by weight | 0.5 | 0.5 | 0.5 | 0.5 | 0.5 | 0.4 | 0.5 |

Properties

| | | | | | | | | |
|---|---|---|---|---|---|---|---|---|
| Modulus of elasticity | MPa | 8,500 | 13,700 | 8,500 | 8,600 | 8,200 | 8,300 | 6,700 |
| Breaking strength | MPa | 112 | 105 | 110 | 105 | 99 | 96 | 103 |
| Breaking elongation | % | 2.6 | 1.3 | 2.8 | 3.0 | 2.4 | 2.8 | 5.8 |
| Impact 23° C. | kJ/m² | 52 | 34 | 50 | 55 | 40 | 32 | 84 |
| Impact −30° C. | kJ/m² | 40 | 30 | 40 | 39 | 39 | 28 | 82 |
| Notch impact 23° C. | kJ/m² | 12 | 11 | 11 | 11 | 13 | 11 | 17 |
| Notch impact −30° C. | kJ/m² | 9 | 9 | 9 | 9 | 9 | 9 | 11 |
| HDT A (1.80 MPa) | ° C. | 204 | 212 | 204 | 201 | 205 | 155 | 207 |
| HDT C (8.00 MPa) | ° C. | 162 | 183 | 160 | 141 | 137 | 103 | 149 |
| MVR (250° C./21.6 kg) | cm³/10 min | 326 | 98 | 253 | 235 | 97 | 590 | 65 |

% by weight = percent by weight

The measurements were implemented according to the following standards and on the following test pieces in the dry state. This means that the test pieces are stored after the injection moulding for at least 48 h at room temperature in a dry environment, over silica gel, before they are supplied for the tests.

The thermal behaviour (melting point (TM), melting enthalpy (ΔHm), glass transition-temperature (Tg)) was determined by means of the ISO standard 11357 (11357-2 for the glass transition temperature, 11357-3 for the melting temperature and the melting enthalpy) on the granulate. The differential scanning calorimetry (DSC) was implemented at a heating rate of 20° C./min.

The relative viscosity (ηrel) was determined according to DIN EN ISO 307 on solutions of 0.5 g polymer dissolved in 100 ml m-cresol at a temperature of 20° C. Granulate is used as sample.

Modulus of elasticity in tension, breaking strength and breaking elongation: modulus of elasticity in tension, breaking strength and breaking elongation were determined according to ISO 527 at a tensile speed of 1 mm/min (modulus of elasticity in tension) or at a tensile speed of 5 mm/min (breaking strength, breaking elongation) on the ISO test bar, standard ISO/CD 3167, type AI, 170×20/10×4 mm at a temperature 23° C.

Impact strength and notch impact strength according to Charpy were measured according to ISO 179/keU or ISO 179/keA on the ISO test bar, standard ISO/CD 3167, type B1, 80×10×4 mm at a temperature of 23° C.

The MVR (melt volume-flow rate) is determined according to ISO 1133 by means of a capillary rheometer, the material (granulate) being melted in a heatable cylinder at a temperature of 250° C. and being pressed through a defined nozzle (capillary) at a pressure produced by the overlay load of 21.6 kg. The emerging volume of the polymer melt is determined as a function of time.

The thermal dimensional stability in the form of HDT A (1.80 MPa) and HDT C (8.00 MPa) was determined according to ISO 75-1 and ISO 75-2 on ISO impact bars of the dimension 80××10×4 mm (test pieces in flat-laid position).

By the use according to the invention of component (C), the mechanical properties, in particular the breaking strength, the breaking elongation and also the impact- and notch impact strength could be significantly improved.

Significantly higher property improvements are thereby achieved than when using normal adhesives, such as e.g. maleic anhydride-grafted polyolefins (CE6). By addition of aliphatic polyamide, such as e.g. PA12, the strength and the breaking elongation are in fact increased but, at the same time, rigidity and breaking strength are reduced (CE7). Only the use according to the invention of component C allows simultaneous improvement in strength, breaking elongation and breaking strength without the rigidity being reduced.

1-14. (canceled)

15. A polyketone moulding compound comprising or consisting of
(A) 25-99.9% by weight of at least one aliphatic polyketone;
(B) 0-70% by weight of filling- or reinforcing materials;
(C) 0.1-6% by weight of at least one phosphorus-containing compound, selected from the group consisting of
(C1) 0-6% by weight of at least one phosphinic acid or at least one diphosphinic acid, a metal salt and/or an organic derivative thereof;
(C2) 0-2% by weight of at least one organic phosphite or phosphonite,
wherein at least one of the phosphorus-containing compounds (C1) and (C2) is present in the polyketone moulding compound, so that the sum of the phosphorus-containing compounds (C1) and (C2) is at least 0.1% by weight, and
(D) 0-20% by weight of at least one additive,
the sum of (A) to (D) producing 100% by weight, the amounts for (A) to (D) including (C1) and (C2) respectively relating to the moulding compound or the sum of (A) to (D).

16. The polyketone moulding compound according to claim 15, wherein, respectively independently of each other or in combination with each other, the amount
(A) of the at least one aliphatic polyketone is 32 to 89.7% by weight,
(B) of the filling- or reinforcing materials is 10 to 60% by weight,
(C) of the at least one phosphorus-containing compound is 0.2 to 4% by weight, and
(D) of the at least one additive is 0.1 to 6% by weight.

17. The polyketone moulding compound according to claim 15, wherein the at least one polyketone (A) is a polymer of carbon monoxide and at least one olefinically unsaturated compound, and at least one further olefinically unsaturated compound with at least 3 carbon atoms, and mixtures thereof.

18. The polyketone moulding compound according to claim 15, wherein the at least one polyketone (A) is a terpolymer of the subsequent general formula
*CH₂—CH₂—COₓ(Q-CO_{y}*
wherein Q is a divalent group derived from olefinically unsaturated compounds with at least 3 carbon atoms, and the molar ratio y:x is less than or equal to 0.5.

19. The polyketone moulding compound according to claim 15, wherein the at least one aliphatic polyketone
a) is a partially crystalline polyketone,
b) has a melt viscosity (MVR, melt volume-flow rate), determined according to ISO 1133 at 240° C. and with a load of 2.16 kg, in the range of 5-200 cm³/10 min,
c) has a relative viscosity, measured on solutions of 0.5 g polyketone dissolved in 100 ml m-cresol at 20° C. with a capillary viscometer, of 1.5 to 2.5, and/or
d) has a number-average molar mass, determined by means of GPC in hexafluoroisopropanol relative to PMMA standards, in the range of 20,000 to 100,000 g/mol.

20. The polyketone moulding compound according to claim 15, wherein the filling- or reinforcing materials are selected from the group consisting of fibrous or particulate filling materials or the mixtures thereof, which are optionally equipped with a size and/or an adhesive.

21. The polyketone moulding compound according to claim 20, wherein the fibrous filling materials
a) are selected from the group consisting of glass fibres, carbon fibres, metal fibres, aramide fibres, basalt fibres and whiskers and mixtures or combinations thereof,
b) are present in the form of endless strands and/or in cut form, and/or
c) have a circular cross-section or a non-circular cross-section, mixtures thereof.

22. The polyketone moulding compound according to claim 20, wherein the particulate filling materials are selected from the group consisting of mineral particulate filling materials.

23. The polyketone moulding compound according to claim 15, wherein the at least one phosphorus-containing compound is selected from:
0.1-6% by weight of at least one phosphinic acid, of at least one diphosphinic acid and a metal salt of these phosphinic acids (component C1), or
0.1-2% by weight of an organic phosphite or phosphonite (component C2), or
0.1-6% by weight of a mixture of phosphinic acid or diphosphinic acid or a metal salt of these phosphinic acids (component C1) and of an organic phosphite or phosphonite (component C2), the mixture consisting up to 0.05-2% by weight of component C2 and up to 0.05-5.95% by weight of component C1.

24. The polyketone moulding compound according to claim 15, wherein the at least one phosphinic acid and the metal salts derived therefrom are of general formula (I) or the at least one diphosphinic acid and the metal salts derived therefrom of general formula (II) 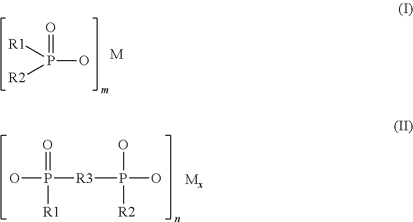
wherein
R1, R2 are the same or different and preferably are C1-C8 alkyl, linear or branched, saturated, unsaturated or partially unsaturated and/or aryl;
R3 is C1-C10 alkylene, linear or branched, saturated, unsaturated or partially unsaturated, C6-C10 arylene, alkylarylene or arylalkylene;
M is a hydrogen ion (proton) or a metal ion from the 2^{nd} or 3^{rd} main or subsidiary group of the periodic table; and
m=2 or 3; n=1 or 3; x=1 or 2.

25. The polyketone moulding compound according to claim 15, wherein the at least one organic phosphite or phosphonite (component C2) is selected from the group consisting of triphenylphosphite, diphenylalkylphosphite, phenyldialkylphosphite, tris(nonylphenyl)phosphite, trilaurylphosphite, trioctadecylphosphite, di stearylpentaerythritol diphosphite, tris(2,4-di-tert-butylphenyl)phosphite, diisodecylpentaerythritol diphosphite, bis(2,4-di-tert-butylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris-(tert-butylphenyl))pentaerythritol diphosphite, tristearylsorbitol triphosphite, tetrakis(2,4-di-tert-butylphenyl)-4,4′-biphenylene diphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyldibenzo[d,g]-1,3,2-dioxaphosphocine, bis(2,4-di-tert-butyl-6-methylphenyl)methylphosphite, and bis(2,4-di-tert-butyl-6-methylphenyl)ethylphosphite.

26. The polyketone moulding compound according to claim 15, wherein the at least one additive (component D) is selected from the group consisting of stabilisers, antioxidants, processing aids, polymers different from aliphatic polyketones, impact modifiers, adhesives, crystallisation accelerators or retarders, flow aids, lubricants, mould-release agents, plasticisers, radical collectors, antistatic agents, colouring- and marking substances, nanoparticles in lamellar form, layer silicates, conductivity additives, residues from polymerisation processes, oxygen-, nitrogen- or sulphur-containing metal compounds and regulators, and mixtures or combinations hereof.

27. A moulded article produced from a polyketone moulding compound according to claim 15.

28. A method for the production of a moulded article according to claim 27, comprising injection moulding, extrusion moulding, or blow-moulding.
